(19) United States
(12) Patent Application Publication
(10) Pub. No.: US 2007/0189354 A1
(43) Pub. Date: Aug. 16, 2007

(54) Electrode in contact with a substance to be measured, and method for the production thereof

(76) Inventors: Dieter Keese, Wahlsburg (DE); Wilfried Conrady, Dudenstadt (DE)

Correspondence Address: Michael M Rickin;Abb Inc, Legal Dept-4U6, 29801 Euclid Avenue, Wickliffe, OH, 44092-1832, US

(21) Appl. No.: 11/630,925

(22) PCT Filed: Jun. 30, 2005
(86) PCT No.: PCT/EP05/07047

§ 371 Date: Dec. 27, 2006

(30) Foreign Application Priority Data
Jun. 30, 2004 (DE) 102004031642.2
Jun. 29, 2005 (DE) 102005030713.2

(51) Int. Cl. H05B 7/14

(52) U.S. Cl. 373/92

(57) ABSTRACT

The invention relates to an electrode which is in contact with a substance to be measured, especially for detecting the measuring values in a magnetic induction flowmeter (IDM), said electrode coming into contact with an abrasive or chemically aggressive substance to be measured (9). The inventive electrode comprises a form-determining base body (8) consisting of a metal that is non-resistant in relation to the substance to be measured (9), the surface of said base body being at least partially provided with a precious metal coating (11) for improving the electroconductivity. Said coating establishes the electrical contact with an envelope body (10) which is resistant in relation to the substance to be measured (9), surrounds the base body (8), and establishes the contact with the substance to be measured (9).

The present invention relates to an electrode in contact with a substance to be measured, in particular for acquiring measured values in a magnetic induction flowmeter (IDM), which electrode comes into contact with a substance to be measured that is abrasive or chemically aggressive. Furthermore, the invention relates to a magnetic induction flowmeter having such a measuring electrode and a method for the production thereof.

For the purpose of volumetric flow measurements, the magnetic induction flowmeters which are of interest here are primarily used. These are used for continuous or pulsating flow measurement of conductive, homogenous or multiphase substances to be measured, and also for filling and metering processes. Points in favor of the use of magnetic induction flowmeters are the high range of nominal widths, a measuring range span of 1:100, high accuracies and also the possibility of simple, trouble-free cleaning of the regularly smooth, clear measuring tube. The main applications of IDMs include many applications in the paper and pulp industry from water conditioning and stock preparation via the metering of additives and the like.

The measuring principle in magnetic induction flowmeters is based on the induction law. This physical effect is used in order to measure the flow velocity through the measuring tube of the substance to be measured. This is because if an electrically conductive substance to be measured is led through a magnetic field B, an electric field E is produced in the substance to be measured which electric field is oriented at right angles to the flow velocity v and to the magnetic field direction. The following is true:
E=B×v

The potential of the electric field E representing the flow velocity is usually measured via electrodes in contact with the substance to be measured.

DE 101 14 103 A1 discloses a magnetic induction flowmeter which is flange-mounted in a pipeline. The substance to be measured flows through the pipeline and through the measuring tube of the magnetic induction flowmeter. Provided around the measuring tube is a measuring arrangement, a magnetic arrangement here, which is electrically conductively connected to the flowing substance to be measured via electrodes passing through the wall of the measuring tube, which is provided with a non-electrically conductive lining.

DE 101 28 607 A1 discloses generic electrodes of this type that are in contact with a substance to be measured, which are led through the wall of a measuring tube and, on the side projecting into the measuring tube, come into contact with the substance to be measured flowing past. Via this electrical connection, the flow-dependent effect explained previously can be measured in an inductive-magnetic way and can then be converted into a flow value. Because of the necessary high conductivity, such electrodes that are in contact with a substance to be measured normally consist of materials which, on the other hand, are unable to permanently withstand chemically abrasive influences of the substance to be measured. As a result of destruction of the electrodes by mechanical or chemical wear, there is the risk of failure of the flowmeter, so that the substance to be measured is able to cause further damage in installations and environment. Furthermore, in the case of explosive substances, there is of course also an acute risk of explosion if these can emerge through the wall of the measuring tube through worn-out electrodes or electrode openings. In order to eliminate these problems, it is proposed in this prior art to construct the electrode in contact with a substance to be measured from an external enveloping electrode with a second security electrode arranged therein in an insulated manner. The electrode in contact with the substance to the measured is constructed in practical terms as a thick-walled hollow body and a second, security electrode insulated from the electrode in contact with the substance to be measured is placed in the interior. Then, if the abrasive attack on the measuring electrode leads to actual removal of electrode material over time, at the instant at which the aforementioned hollow-body-like outer enveloping electrode is eroded through, the substance to be measured activates the inner security electrode, which can be determined immediately via appropriate evaluation electronics.

This technical solution thus provides a security function. However, this does not change the fact that the electrode itself must be fabricated from the most resistant material in order to achieve the longest possible service life when used in connection with abrasive or chemically aggressive substances to be measured. Thus, the entire electrode head is conventionally fabricated from platinum or another suitable noble metal.

The disadvantages in this case are the quite high material costs and the low mechanical strength of the material.

The object of the present invention is therefore to provide an electrode in contact with a substance to be measured, in particular for acquiring measured values in a magnetic induction flowmeter, which electrode requires little expenditure on material and ensures adequate resistance to abrasive or chemically aggressive substances to be measured.

On the basis of an electrode in contact with a substance to be measured according to the preamble of claim 1, the object is achieved in conjunction with its characterizing features. In terms of the method, the object is achieved by the features of claim 10. Further advantageous refinements are specified in other dependent claims.

The invention includes the technical teaching that an electrode in contact with a substance to be measured is provided from a shape-determining base body of a metal which is not resistant to the substance to be measured, whose surface is at least partly provided with a noble metal coating in order to improve the electrical conductivity, which produces the electrical contact with an enveloping body which surrounds the base body, is resistant to the substance to be measured and is in electrical contact with the substance to be measured.

The advantage of the solution according to the invention is in particular that, by means of the simple material of the base body, the material costs can be lowered significantly overall. This is because the shape-determining base body consists of a conventional metal and is used merely to determine the basic shape of the electrode and to lead the measured signal through electrically. On the other hand, the expensive, resistant material is used only for the thin enveloping body exposed directly to the abrasive or chemically aggressive substance to be measured. The mechanical strength of the electrode can thus be ensured over a long time with a simultaneous reduction in the material costs.

The enveloping body of the electrode in contact with the substance to the measured can consist of a sheet metal or a noble metal foil, the metal preferably selected from the group comprising the secondary group metals: platinum, gold, tantalum or alloys thereof. It is also conceivable—depending on the level of resistance desired or the type of the substance to be measured—to use other secondary group metals, such as: Ti, V, Cr, Mn, Fe, Co, Ni, Cu, Zn or alloys thereof.

However, as an alternative to this, it is also possible to produce the enveloping body from an electrically conductive plastic film. As compared with the aforementioned noble metals, such plastic films are quite inexpensive and, furthermore, also exhibit adequate resistance to abrasive or chemically aggressive substances to be measured.

The enveloping body is preferably applied to the base body by shaping, so that the two joined partners enter into a substantially form-fitting connection. As a result of this measure, the electrode in contact with a substance to be measured can be joined together in a particularly simple way.

As compared with the enveloping body, the base body can consist of a conventional electrically conductive metal, such as copper, zinc, iron or alloys thereof, such as brass and the like.

The noble metal coating applied thereto is used to improve the electrical contact between base body and enveloping body. The noble metal coating should preferably consist of the same material as the enveloping body, for example likewise of platinum, gold, tantalum or alloys thereof.

The noble metal coating can be applied in a simple way by means of electroplating or by means of vapor deposition. In this way, a material-saving low layer thickness can be achieved with reliable adhesion to the base body.

A further measure improving the invention is that, for the purpose of operational monitoring of the measuring electrode, the electrical voltage produced by damage to the enveloping body is registered between the enveloping body and the base body and is signaled by evaluation electronics connected downstream. This is because, as a result of the action of the abrasive or chemically aggressive substance to be measured on the surface of the enveloping body, the latter is damaged over the course of time. Once the enveloping body has been broken through, a galvanic element is produced on the electrode itself, of which the voltage can be evaluated appropriately.

Further measures improving the invention will be illustrated in more detail below, together with the description of a preferred exemplary embodiment of the invention, by using the figures, in which:

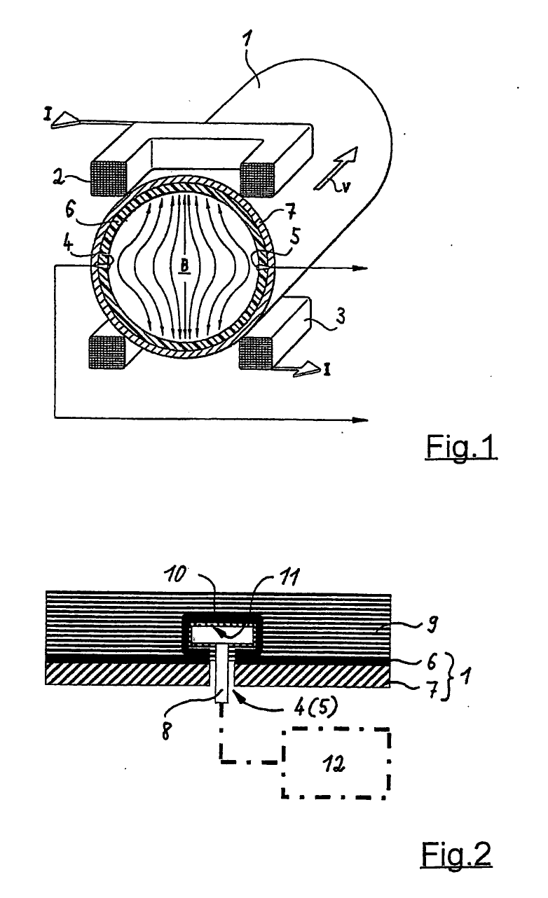

FIG. 1 shows a schematic perspective illustration of a magnetic induction flowmeter having two electrodes in contact with a substance to be measured, and

FIG. 2 shows a longitudinal section through the measuring tube of the flowmeter according to FIG. 1 in the region of one of the electrodes.

The magnetic induction flowmeter (IDM) illustrated in FIG. 1 has a measuring tube 1, through which an electrically conductive substance to be measured, whose volumetric flow is to be determined, flows with the velocity v. Two exciter coils 2 and 3 which belong to the magnetic arrangement and which are arranged opposite each other on the outside of the measuring tube 1 have an alternating current or a pulsating direct current I applied to them, so that a magnetic field E is produced in the interior of the measuring tube 1. The voltage induced in this way in the substance to be measured is tapped off at two electrodes 4 and 5, likewise arranged opposite each other and in an insulated manner in the measuring tube 1.

The side of the two electrodes 4 and 5 that faces the interior of the measuring tube 1 is in each case in contact with an abrasive and/or chemically aggressive substance to be measured, whereas the respective opposite side of the electrodes 4 and 5 in contact with the substance to be measured is connected via an electric lead to evaluation electronics, not further illustrated here. The measuring tube 1 has an inner part 6 made of plastic, which is surrounded by a metallic outer part 7. The inner part 6 has the function of insulating the metallic outer part 7 from the electrically conductive substance to be measured.

According to FIG. 2, the measuring electrode 4 illustrated by way of example here is fixed to the inner part 6 of the measuring tube 1 in an electrically insulated manner via its shape-determining base body 8. In the region of the substance 9 to be measured, the electrode 4 has an enveloping body 10 which produces the contact with the substance 9 to be measured. The enveloping body 10 in this exemplary embodiment consists of platinum, that is to say a material which is quite resistant to chemically aggressive substances to be measured. In order to produce a high-quality electrical contact between the enveloping body 10 and the base body 8, the surface of the base body 8 in the region close to the substance to be measured is provided with a noble metal coating 11. The enveloping body 10 is applied to the base body 8 by shaping, so that the result is a substantially form-fitting connection between the two parts. The noble metal coating 11 is likewise implemented from platinum here, coinciding with the material of the enveloping body 10, whereas the base body 8 itself in this exemplary embodiment consists of brass. The noble metal coating 11 is applied to the surface of the base body 8 by electroplating.

Furthermore, the measuring electrode 4 is connected to evaluation electronics 12, which are used for operational monitoring of the measuring electrode 4. Damage to the enveloping body 10 produces a galvanic element on the measuring electrode 4, whose galvanic voltage is registered and signaled by the evaluation electronics 12 connected downstream. The signal provides a reference to the fact that the electrode is damaged and must be replaced.

The invention is not restricted to the preferred exemplary embodiment described above. Instead, modifications from this are also conceivable, which fall within the scope of the following claims. For example, it is entirely conceivable for the enveloping body and the noble metal coating of the base body to be produced from a different noble metal which is resistant to the respective abrasive and chemically aggressive substance to be measured. Furthermore, it is also conceivable for at least the enveloping body to be produced from an electrically conductive plastic film.

### LIST OF DESIGNATIONS

1 Measuring tube
2 Exciter coil
3 Exciter coil
4 Electrode
5 Electrode
6 Inner part
7 Outer part
8 Base body
9 Substance to be measured
10 Enveloping body
11 Noble metal coating
12 Evaluation electronics
v Velocity
I Electric current
B Magnetic field

1. An electrode in contact with a substance to be measured, in particular for acquiring measured values in a magnetic induction flowmeter (IDM), which electrode comes into contact with a substance to be measured that is abrasive or chemically aggressive, characterized in that a shape-determining base body (8) of a metal which is not resistant to the substance (9) to be measured is provided, whose surface is at least partly provided with a noble metal coating (11) in order to improve the electrical conductivity, which produces the electrical contact with an enveloping body (10) which surrounds the base body (8), is resistant to the substance (9) to be measured and is in contact with the substance (9) to be measured.

2. The electrode in contact with a substance to be measured as claimed in claim 1, characterized in that the enveloping body (10) consists of a sheet metal or a noble metal foil, the metal preferably selected from the group comprising the secondary group metals: platinum, gold, tantalum or alloys thereof.

3. The electrode in contact with a substance to be measured as claimed in claim 1, characterized in that the enveloping body (10) consists of an electrically conductive plastic film.

4. The electrode in contact with a substance to be measured as claimed in claim 1, characterized in that the enveloping body (10) is applied to the base body (8) by shaping and enters into a form-fitting connection with the latter.

5. The electrode in contact with a substance to be measured as claimed in claim 1, characterized in that the base body (8) consists of a metal preferably selected from the group comprising the electrically conductive elements: copper, zinc, iron or alloys thereof.

6. The electrode in contact with a substance to be measured as claimed in claim 1, characterized in that the noble metal coating (11) consists of a noble metal, preferably selected from the group comprising the secondary group metals: platinum, gold, tantalum or alloys thereof.

7. The electrode in contact with a substance to be measured as claimed in claim 1, characterized in that the noble metal coating (11) for improving the electrical conductivity is produced by means of electroplating or by means of vapor deposition, in order to achieve a material-saving low layer thickness with reliable adhesion to the base body (8).

8. A magnetic induction flowmeter having a measuring tube (1) through which a substance (9) to be measured flows, and a magnetic system (2, 3) surrounding the measuring tube (1), and at least one pair of electrodes (4, 5) that are in contact with the substance to be measured, as claimed in one of the preceding claims.

9. The magnetic induction flowmeter as claimed in claim 8, characterized in that, for the purpose of operational monitoring of the measuring electrode (4, 5), the electrical voltage produced by damage to the enveloping body (10) is registered between the enveloping body (10) and the base body (8) and is signaled by evaluation electronics (12) connected downstream.

10. A method for producing an electrode in contact with a substance to be measured as claimed in claim 1, comprising the following production steps:
a shape-determining base body (8) made of a metal not resistant to the substance (9) to be measured is at least partly provided with a noble metal coating (11),
an enveloping body (10) that is resistant to the substance (9) to be measured is then applied to the base body (8) by shaping.

11. The method as claimed in claim 10, characterized in that the noble metal coating (11) is dimensioned in such a way that when the latter is damaged or eroded by the medium to be measured during operation, a galvanic element is produced together with the material of the remaining electrode, and the damage is registered from outside via registration of this EMF (electromotive force) that is produced.
